(19) United States
(12) Patent Application Publication
(10) Pub. No.: US 2010/0164677 A1
(43) Pub. Date: Jul. 1, 2010

(54) FUSE

(76) Inventor: Chin-Chi Yang, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/344,972

(22) Filed: Dec. 29, 2008

(51) Int. Cl. H01H 85/04

(52) U.S. Cl. 337/159; 337/161; 337/292

(57) ABSTRACT

A fuse has a base and multiple wires. The base is an insulator and has a top surface and multiple contact plates. The contact plates are mounted separately on the top surface of the base. The wires are high density conductive alloy including Al 60˜90 wt %, Mg 22˜30 wt %, Si 1˜3 wt % and Cu 1˜3 wt % and connect the contact plates in series. Since the wires are directly heated, response time, sensitivity, power waste and heating resistor damage problems are solved and because the wires are high density conductive alloy that is nearly independent of environmental temperature, the temperature dependency, installation position limitation and leakage current problems are also solved.

### BACKGROUND OF THE INVENTION

1. Field of Invention

The present invention relates to a fuse, and more particularly to a fuse having multiple high density conductive alloy wires.

2. Description of the Related Art

Electronic apparatuses are integrated into daily life and generally comprise a fuse for safety. Different fuses are installed inside electronic apparatuses or connecting boxes for protecting the electronic apparatuses and power wire network.

With reference to FIG. 8, an equivalent circuit of a conventional fuse (90) comprises two low temperature melting fuses (91) and two heating resistors (92). Each low temperature melting fuse (91) is a plate or sheet. Each heating resistor (92) is mounted below a corresponding low temperature melting fuse (91). When the conventional fuse apparatus (90) is installed inside an external overloaded circuit, each heating resistor (92) is heated, thereby heating the corresponding low temperature melting fuse (91), when the low temperature melting fuse (91) reaches a critical temperature, the low temperature melting fuse (91) is broken to protect the circuit and electronic apparatuses connected with the external circuit.

However, since most present consumer electronic products are low power and low current, the conventional fuse (90) is unable to protect the present consumer electronic products because the conventional fuse (90) is not sensitive enough to be melted.

The conventional fuse (90) has a long response time, low sensitivity to input current, is environmental temperature dependent, wasteful of power required for heating the heating resistor (92), capable of causing heating resistor (92) damage, has limited installation positions, and after a blowout current may leak through residual molten conventional low temperature melting fuse (91) as detailed below.

Under current electrical apparatus conditions, the conventional fuse (90) is rarely operated under an operation current lower than 12A. Although the operation current of the conventional fuse (90) is defined at 12A, 24A are required for heating the resistor (92) to melt the low temperature melting fuse (91).

With further reference to FIGS. 9 to 11, when plotting current against melting-time (to be blowout) for two conventional fuses with different model types, the conventional fuses are not sensitive enough to protect the electronic products and apparatuses since over 50A current is needed for a short melting time. Such high current would damage sensitive electronic apparatuses. Further, the melting time is also dependent on voltage and power, therefore specific fuses must be selected and implemented in different electronic apparatus.

Once the heating resistor (92) is damaged by an overloaded input power, the conventional fuse (90) is fail and is no longer able to protect the circuit loop and apparatuses.

After being heated, the low temperature melting fuse (91) is molten so installation position and attitude of the conventional fuse (90) is limited to prevent a molten low temperature melting fuse (91) damaging the circuit loop.

A melting time dependents on input voltage as shown in FIGS. 10 and 11. The conventional fuse apparatuses (90) with different models are measured, where each model type of the conventional fuse apparatuses (90) has different melting time when different input voltage is applied.

Since the conventional low temperature melting fuse (91) is melted, a performance is temperature dependent, so current decay rate changes by nearly 50 wt % over a temperature range of 25 to 80° C., therefore the low temperature melting fuse (91) will be melted rapidly under high temperatures.

When the heating resistor (92) is heated to 135° C., over 1 min is required to melt the low temperature melting fuse (91), however, a PCB board near the heating resistor (92) may also be melted under such temperature.

A response time of the heating resistor (92) of the conventional fuse (90) is 0.3 sec to 4.5 sec, which is not fast enough to protect the circuit loop.

The present invention provides a fuse to obviate or mitigate the shortcomings of the conventional fuse.

### SUMMARY OF THE INVENTION

The primary objective of the present invention is to provide a fuse having multiple high density conductive alloy wires.

A fuse has a base and multiple wires. The base is an insulator and has a top surface and multiple contact plates. The contact plates are mounted separately on the top surface of the base. The wires are high density conductive alloy comprising Al 60˜90 wt %, Mg 22˜30 wt %, Si 1˜3 wt % and Cu 1˜3 wt % and connect the contact plates in series. Since the wires are directly heated, response time, sensitivity, power waste and heating resistor damage problems associated with conventional fuses are solved and because the wires are high density conductive alloy that is nearly independent of environmental temperature, temperature dependency, installation position limitation and leakage current problems associated with conventional fuses are also solved. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a fuse in accordance with the present invention;

FIG. 2 is an exploded perspective view of the fuse having a cover in FIG. 1;

FIG. 3 is a perspective view of the fuse in FIG. 2;

FIG. 4 is an equivalent circuit of the fuse in FIG. 1;

FIG. 5 is a perspective view of the fuse having three contact plates in accordance with the present invention;

FIGS. 6A˜6D are equivalent circuits of the fuse in FIG. 4 connected to different functional devices;

FIG. 7 is an operational view of the fuse in FIG. 6B;

FIG. 8 is an equivalent circuit of a conventional fuse;

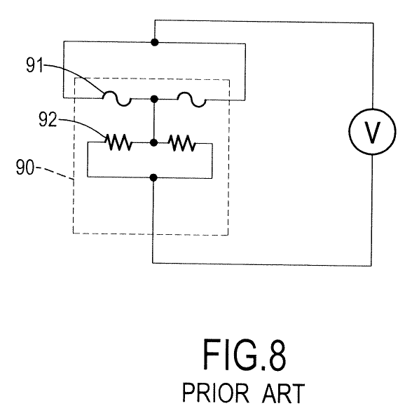

FIG. 9 is a graph of melting time against current of the conventional fuse in FIG. 8;

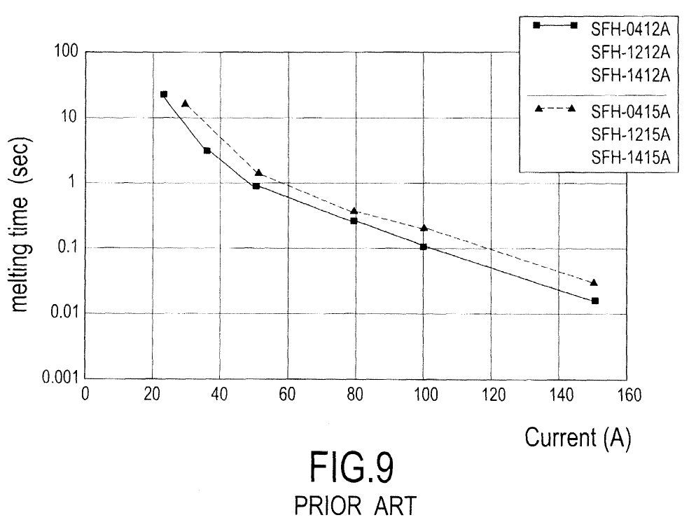

FIG. 10 is a graph of melting time against power of the conventional fuse in FIG. 8; and

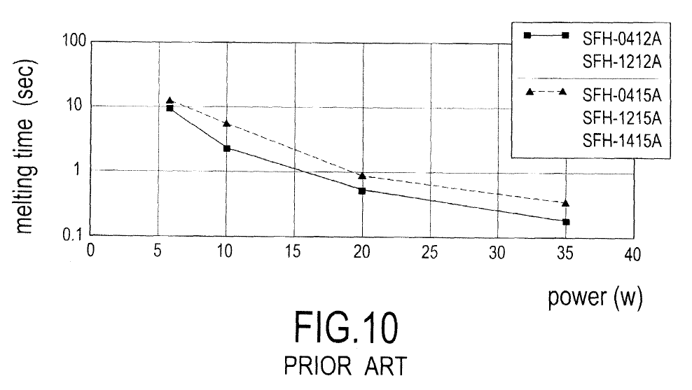

FIG. 11 is a graph of melting time against voltage of the conventional fuse in FIG. 8;

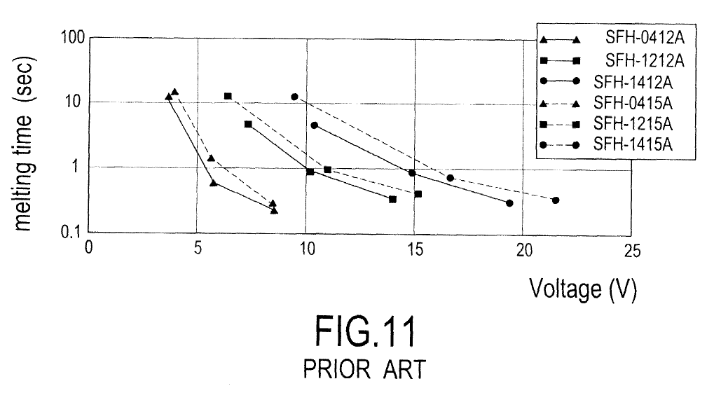

### DETAILED DESCRIPTION OF THE INVENTION

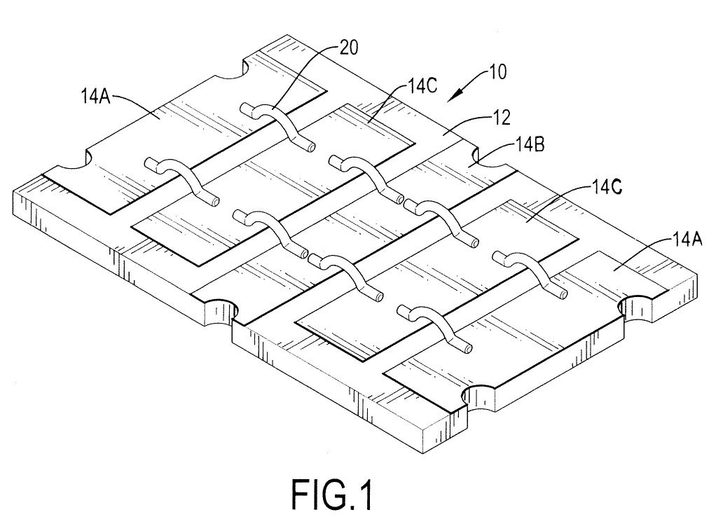

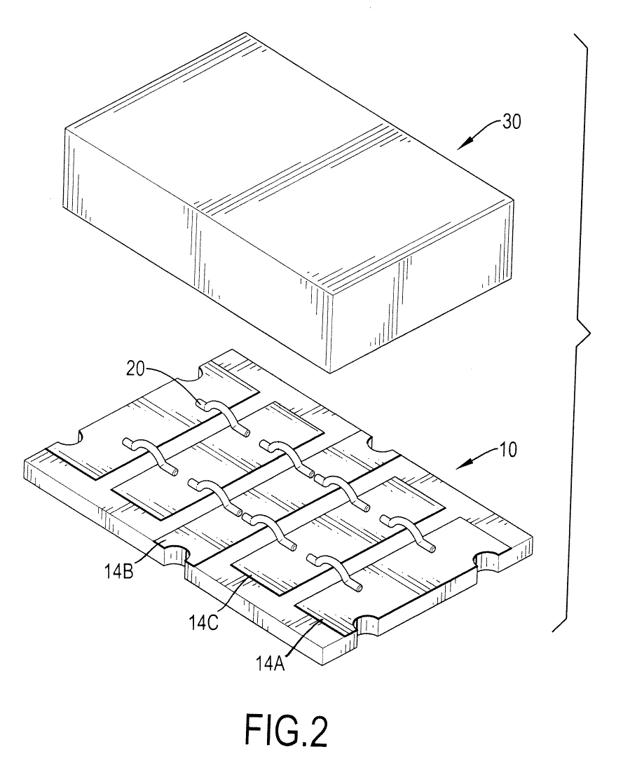

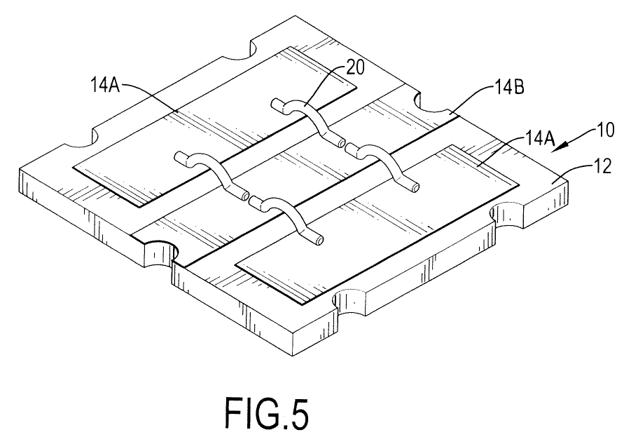

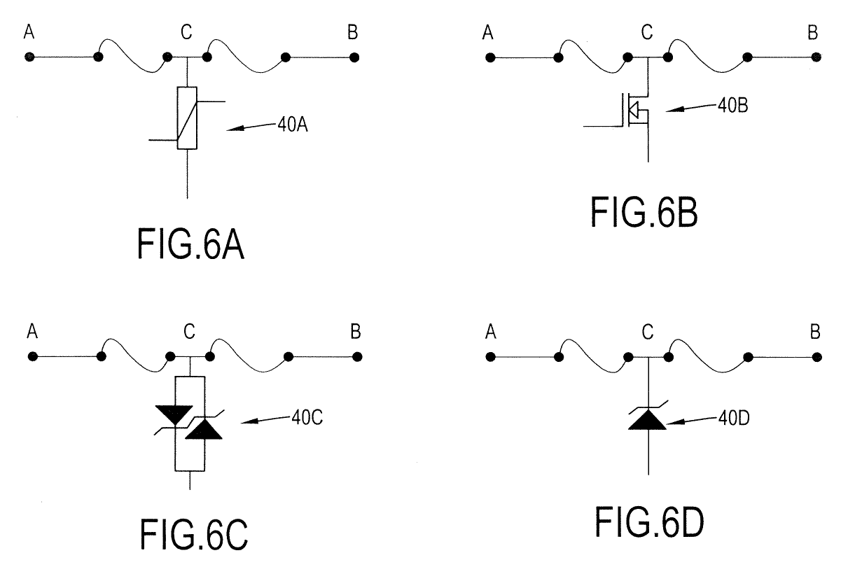

With reference to FIGS. 1, 2, 5 and 6A˜6D, a fuse in accordance with the present invention comprises a base (10), multiple wires (20), an optional cover (30) and an optional functional device (40A˜40D).

The base (10) is an insulator, may be a printed circuit board, a bakelite resin broad or the like and has a top surface and multiple contact plates (14) and may have an edge and multiple connection recesses.

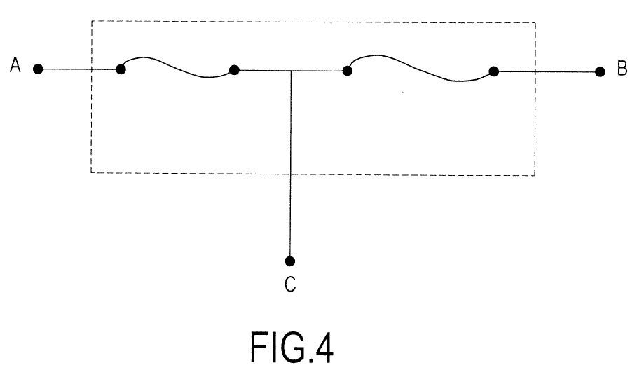

With further reference to FIG. 4, the contact plates (14) are separately attached to the top surface of the base (10), may be mounted on or formed on the base (10), are separated by an interval, may be rectangular copper plates, may align with the edge of the base (10) and may comprise two connecting plates (14A), a bypass plate (14B) and multiple bridging plates (14C). The connecting plates (14A) are attached to the base (10) adjacent to opposite edges of the base (10). The bypass plate (14B) is aligned with and attached to the base (10) between the connecting plates (14A). The bridging plates (14C) are aligned with and attached to the base (10) between the bypass plate (14B) and respective connecting plates (14A).

The wires (20) are high density conductive alloy having a same length and thickness and comprise Aluminum (Al) 60˜90 wt %, Magnesium (Mg) 22˜30 wt %, Silicon (Si) 1˜3 wt %, Copper (Cu) 1˜3 wt % and may comprise impurities and connect the contact plates (14) in series. The thickness of the wires (20) may be less than 2 mm for preventing a residual conductive material generated by the melted wire (20). Multiple wires (20) may connect two adjacent contact plates (14) and two wires (20) may parallelly connect two adjacent contact plates (14) to prevent a native defect of one wire (20) causing a failure.

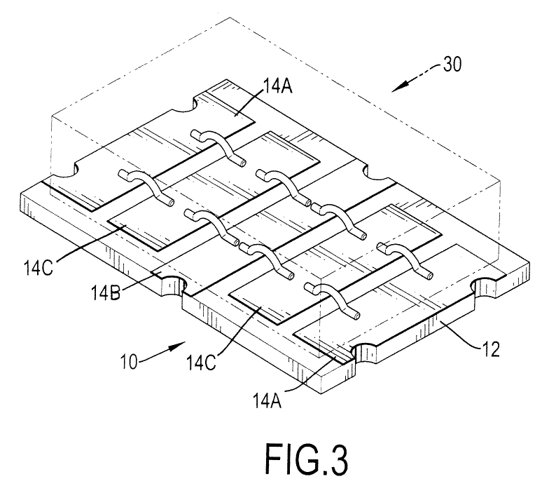

With further reference to FIG. 3, the cover (30) may be translucent, is detachably mounted on the base (10) to cover the wires (20) and may cover the top surface of the base (10) to prevent the wires (20) being damaged by external forces, especially during installation and has multiple optional through holes. The through holes are formed through the cover (30) to allow connection of the fuse to an external circuit. Moreover, the cover (30) also prevents the wires (20) damaging a circuit loop applying the fuse in accordance with the present invention during blowout.

When connected to the circuit loop, input current form the circuit loop flows through the wires (20) and heats up the wires (20). The wires (20) blowout if the input current is beyond a loading limit. Because the wires (20) are directly heated, response time, sensitivity, power waste and heating resistor damage problems associated with conventional fuses are solved. Because the wires (20) are high density conductive alloy that is nearly independent of environmental temperature, the temperature dependency, installation position limitation and leakage current problems associated with conventional fuses are also solved.

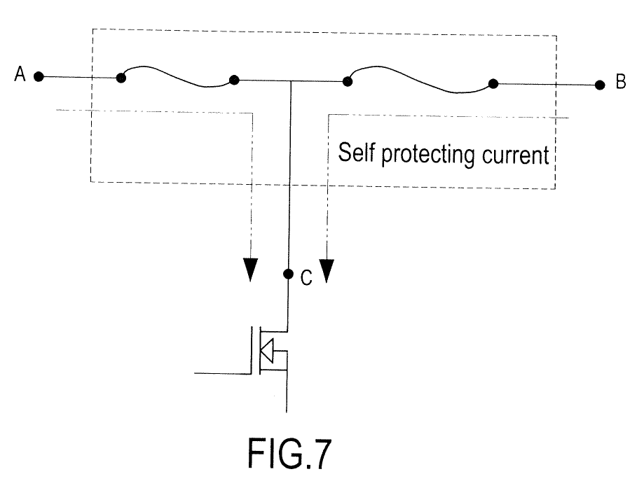

With further reference to FIG. 7, the functional device (40A˜40D) may be a positive temperature coefficient thermistor (PTC) (40A), a transistor (40B), a thyristor (40C), a varistor (40D) such as a transient voltage suppression diode (TVS) or a metal oxide varistor (MOV) that is electronically connected in series to the bypass contact plate (14B). The PTC (40A) protects the circuit loop during high environment temperatures. The transistor (40B) is a controllable switch actuated to generate a bypass to protect the circuit loop under unexpected situations. The thyristor (40C) protects against electrostatic discharge (ESD). The varistor (40D), TVS or MOV, protects against voltage surges.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A fuse comprising:
a base being an insulator having
a top surface; and
multiple contact plates being separately attached to the top surface of the base; and
multiple wires being high density conductive alloy and connecting the contact plates in series, where each adjacent two contact plates are connected by at least two wires.

2. The fuse as claimed in claim 1, wherein the contact plates are separated by an interval and comprise
two connecting plates being attached to the base;
a bypass plate being aligned with and attached to the base between the connecting plates; and
multiple bridging plates aligned with and attached to the base between the bypass plate and respective connecting plates.

3. The fuse as claimed in claim 1, wherein
the contact plates comprise a bypass plate; and
the fuse further comprises a functional device connected in series to the bypass plate.

4. The fuse as claimed in claim 2, wherein
the fuse further comprises a functional device connected in series to the bypass plate.

5. The fuse as claimed in claim 1, wherein
the fuse further comprises a cover being detachably mounted on the base to cover the wires.

6. The fuse as claimed in claim 2, wherein the fuse further comprises a cover being detachably mounted on the base to cover the wires.

7. The fuse as claimed in claim 3, wherein the fuse further comprises a cover being detachably mounted on the base to cover the wires.

8. The fuse as claimed in claim 4, wherein the fuse further comprises a cover being detachably mounted on the base to cover the wires.

9. The fuse as claimed in claim 1, wherein each wire comprises Aluminum (Al) 60˜90 wt %, Magnesium (Mg) 22˜30 wt %, Silicon (Si) 1˜3 wt % and Copper (Cu) 1˜3 wt %.

10. The fuse as claimed in claim 2, wherein each wire comprises Al 60˜90 wt %, Mg 22˜30 wt %, Si 1˜3 wt % and Cu 1˜3 wt %.

11. The fuse as claimed in claim 3, wherein each wire comprises Al 60˜90 wt %, Mg 22˜30 wt %, Si 1˜3 wt % and Cu 1˜3 wt %.

12. The fuse as claimed in claim 4, wherein each wire comprises Al 60˜90 wt %, Mg 22˜30 wt %, Si 1˜3 wt % and Cu 1˜3 wt %.

13. The fuse as claimed in claim 7, wherein each wire comprises Al 60˜90 wt %, Mg 22˜30 wt %, Si 1˜3 wt % and Cu 1˜3 wt %.

14. The fuse as claimed in claim 8, wherein each wire comprises Al 60˜90 wt %, Mg 22˜30 wt %, Si 1˜3 wt % and Cu 1˜3 wt %.

15. The fuse as claimed in claim 14, wherein the functional device is a positive temperature coefficient thermistor (PTC).

16. The fuse as claimed in claim 14, wherein the functional device is a transistor.

17. The fuse as claimed in claim 14, wherein the functional device is a thyristor.

18. The fuse as claimed in claim 14, wherein the functional device is a varistor.

19. The fuse as claimed in claim 14, wherein the functional device is a TVS.

20. The fuse as claimed in claim 14, wherein the functional device is an MOV.
